(19) United States
(12) Patent Application Publication
(10) Pub. No.: US 2026/0147395 A1
(43) Pub. Date: May 28, 2026

(54) ELECTRONIC DEVICE AND METHOD FOR CONTROLLING POWER SUPPLY, AND NONTRANSITORY STORAGE MEDIUM

(71) Applicant: SAMSUNG ELECTRONICS CO., LTD., Suwon-si (KR)

(72) Inventors: Sangjae JUNG, Suwon-si (KR); Jeongseob KIM, Suwon-si (KR); Gyuwon MOON, Suwon-si (KR); Seungchul SON, Suwon-si (KR); Keewook LEE, Suwon-si (KR); Gijae LEE, Suwon-si (KR); Hyongrae CHO, Suwon-si, Gyeonggi-do (KR); Iljoo CHAE, Suwon-si (KR); Junhee HAN, Suwon-si (KR)

(21) Appl. No.: 19/453,258

(22) Filed: Jan. 20, 2026

Related U.S. Application Data
(63) Continuation of application No. PCT/KR2024/010402, filed on Jul. 19, 2024.

(30) Foreign Application Priority Data
Jul. 20, 2023 (KR) 10-2023-0094713
Sep. 20, 2023 (KR) 10-2023-0125795

(51) Int. Cl. G06F 1/26; G06F 1/16; G06F 1/28

(52) U.S. Cl. CPC G06F 1/266; G06F 1/1603; G06F 1/1632; G06F 1/28

(57) ABSTRACT

An electronic device, a method for controlling power supply, and a non-transitory storage medium are provided. The electronic device connects to an external electronic device through a pogo interface included in input/output circuitry of the electronic device, and applies a first output voltage to the pogo interface so as to supply power from a battery of the electronic device to the external electronic device. The electronic device receives, from the external electronic device, through the input/output circuitry, information related to the external electronic device while applying the first output voltage to the external electronic device, and maintains the first output voltage or changes the first output voltage to a second output voltage on the basis of the information related to the external electronic device. The electronic device can apply the maintained first output voltage or the second output voltage to the pogo interface. Other embodiments are also possible.

This application is a continuation application, claiming priority under § 365(c), of International Application No. PCT/KR2024/010402, filed on Jul. 19, 2024, which is based on and claims the benefit of Korean patent application number 10-2023-0094713, filed on Jul. 20, 2023, and Korean patent application number 10-2023-0125795, filed on Sep. 20, 2023, the disclosures of which are incorporated by reference herein in their entireties.

### BACKGROUND

### Field

The disclosure relates to an electronic device, a method, and a non-transitory storage medium for controlling power supply.

### Description of the Related Art

Electronic devices have been provided in various forms, such as smartphones, tablet personal computers (PCs), and personal digital assistants (PDAs), along with the development of digital technology. Electronic devices are also being developed in forms that can be worn by a user to enhance portability and user accessibility.

For example, an electronic device developed in a form that is easy to carry, such as a tablet, may not include accessory devices such as a keyboard, a mouse, or a USB device, and may perform an interface function supportive of its operation by being connected to an accessory device through a connection interface. In general, an accessory device may not include a separate battery and, when connected to an electronic device including a battery, may be driven by receiving power from the battery.

### SUMMARY

The electronic device may be connected to an accessory device (external electronic device) that does not include a power supply source such as a battery, and may supply power of the battery to the accessory device. In the case that the accessory device is to drive components that use a large amount of power (e.g., light emitting diodes (LED)), the accessory device may include a configuration such as a buck booster that boosts power and provides the boosted power to the corresponding components.

However, since the accessory device (external electronic device) boosts a voltage of the power supplied from the electronic device and uses the boosted voltage, a voltage drop inevitably occurs due to physical limitations (e.g., an increase in resistance caused by the distance of a power supply path) between the electronic device and the accessory device. Due to such a voltage drop, LED brightness may not be implemented as bright as desired.

An embodiment of the disclosure provides an electronic device, a method, and a non-transitory storage medium for controlling power supply to an external electronic device by changing an output voltage to a voltage value supportive of driving at least one light emitting element (e.g., an LED).

According to an embodiment of the disclosure, the electronic device may include a battery, power conversion circuitry, input/output circuitry including a pogo interface, at least one processor including processing circuitry, and memory storing instructions.

According to an embodiment, the instructions, when individually or collectively executed by the at least one processor, cause the electronic device to control the input/output circuit to connect to the external electronic device through the pogo interface.

According to an embodiment, the instructions, when individually or collectively executed by the at least one processor, cause the electronic device to control the power conversion circuitry to apply a first output voltage to the pogo interface so as to supply power from the battery to the external electronic device.

According to an embodiment, the instructions, when individually or collectively executed by the at least one processor, cause the electronic device to receive, while the first output voltage is applied to the external electronic device, information related to the external electronic device from the external electronic device through the input/output circuitry.

According to an embodiment, the instructions, when individually or collectively executed by the at least one processor, cause the electronic device to, based on information related to the external electronic device, maintain the first output voltage or change the first output voltage to a second output voltage, and control the power conversion circuitry to apply the maintained first output voltage or the second output voltage to the pogo interface.

According to an embodiment, a method for operating an electronic device may include connecting to an external electronic device through a pogo interface included in an input/output circuitry of the electronic device.

According to an embodiment, the method may include applying a first output voltage to the pogo interface so as to supply power from a battery of the electronic device to the external electronic device.

According to an embodiment, the method may include receiving, while applying the first output voltage to the external electronic device, information related to the external electronic device from the external electronic device through the input/output circuitry.

According to an embodiment, the method may include maintaining the first output voltage or changing the first output voltage to a second output voltage based on the information related to the external electronic device.

According to an embodiment, the method may include applying, to the pogo interface, the maintained first output voltage or the second output voltage resulting from the change.

According to an embodiment, a non-transitory storage medium stores one or more programs, wherein the one or more programs include instructions that, when executed by at least one processor of an electronic device, cause the electronic device to perform connecting to an external electronic device through a pogo interface included in input/output circuitry of the electronic device, applying a first output voltage to the pogo interface to supply power from a battery of the electronic device to the external electronic device, receiving information related to the external electronic device from the external electronic device through the input/output circuitry while applying the first output voltage to the external electronic device, maintaining the first output voltage or changing the first output voltage to a second output voltage, based on the information related to the external electronic device, and applying the maintained first output voltage or the second output voltage to the pogo interface.

### BRIEF DESCRIPTION OF DRAWINGS

FIG. 1 is a block diagram illustrating an electronic device in a network environment according to various embodiments.

FIG. 2 illustrates an electronic device and an external electronic device according to an embodiment.

FIG. 3 illustrates the configuration of an electronic device and an external electronic device according to an embodiment.

FIGS. 4A and 4B illustrate the configuration of an external electronic device according to an embodiment.

FIG. 5 illustrates the configuration of a voltage identification circuit of an external electronic device according to an embodiment.

FIG. 6 illustrates an example of a method for operating an electronic device according to an embodiment.

FIG. 7 illustrates an example of a method for operating an electronic device according to an embodiment.

FIG. 8 illustrates an example of a method for operating an electronic device according to an embodiment.

FIG. 9 illustrates an example of a method for operating an electronic device according to an embodiment.

FIG. 10 illustrates an example of a method for operating an electronic device and an external electronic device according to an embodiment.

FIG. 11 illustrates an example of a method for operating an electronic device according to an embodiment.

FIG. 12 illustrates an example of a method for operating an electronic device according to an embodiment.

With regard to the description of the drawings, the same or like reference numerals may be used to designate the same or like elements.

### DETAILED DESCRIPTION

Hereinafter, embodiments of the disclosure will be described in detail with reference to the accompanying drawings such that those skilled in the art to which the disclosure pertains may easily implement the disclosure. However, the disclosure may be implemented in various different forms and should not be limited to the embodiments described herein. In the description of the drawings, the same or similar reference numerals may be used to refer to the same or similar elements. Moreover, in the drawings and related descriptions, descriptions of well-known functions and configurations may be omitted for clarity and conciseness. As used in an embodiment of the disclosure, the term “user” may refer to a person who uses an electronic device or a device (e.g., an artificial intelligence electronic device) that uses the electronic device.

Terms such as, for example, first, second, and the like may be used to describe various components, but the components should not be limited by the terms. The terms as used herein may distinguish one component from other components and are not to be limited by the terms. For example, without departing the scope of the present disclosure, a first component may be referred to as a second component, and similarly, the second component may also be referred to as the first component. The terms of a singular form may include plural forms unless otherwise specified.

The terminology used herein is for the purpose of describing particular embodiments and is not intended to be limiting. As used herein, “a,” “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, or components.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The term “adjacent” is used to describe the relative positions of various components. The term may refer to a directly adjacent relationship between components but is not necessarily limited or intended to mean that the components are directly adjacent each other. The term may mean that the components are situated in respective regions that are directly adjacent and the components may therefore be mutually proximal and be separated by a gap. For example, the term “adjacent” or “adjacent to,” as used herein, may include “next to,” “adjoining,” “in contact with,” or “in proximity to.”

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases.

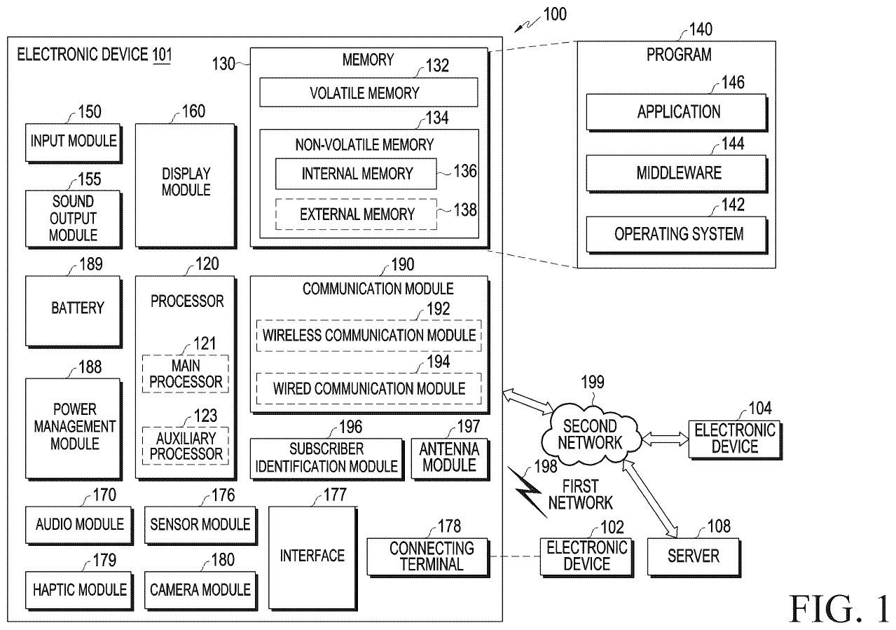

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. In an example in which the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing 1 eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the electronic device 102, the electronic device 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

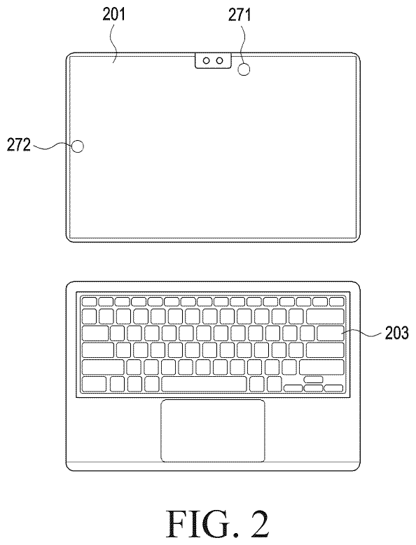

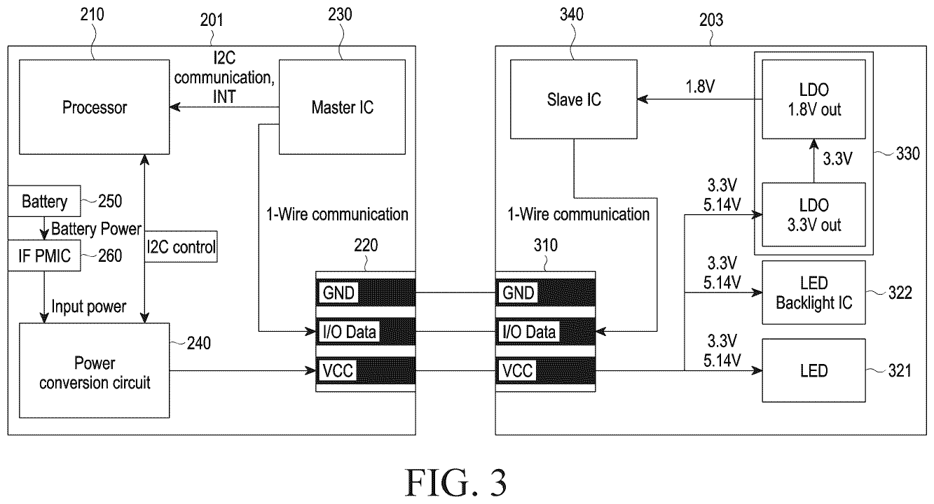

FIG. 2 illustrates an electronic device and an external electronic device according to an embodiment, and FIG. 3 illustrates the configuration of an electronic device and an external electronic device according to an embodiment.

Referring to FIGS. 2 and 3, an electronic device 201 (e.g., the electronic device 101 of FIG. 1) according to an embodiment may include at least one processor 210, input/output circuitry 220 (also referred to herein as an input/output interface or an I/O interface), master integrated circuitry 230, power conversion circuitry 240, and a battery 250. The electronic device 201 according to an embodiment may include power management circuitry 260 (e.g., IF PMIC) for managing power of the battery 250. Without being limited thereto, the electronic device 201 may further include other components described in connection with FIG. 1. The electronic device 201 according to an embodiment may be connected to an external electronic device 203 through a pogo interface (e.g., a connecting terminal or a connection part, spring-loaded pogo pins) included in the input/output circuitry 220, and may supply power of the battery 250 to the external electronic device 203. The electronic device 201 according to an embodiment may include at least one sensor 271 or 272 (e.g., an illuminance sensor or a light detection sensor).

The processor 210 of the electronic device 201 according to an embodiment may be electrically or operatively connected to the input/output circuitry 220, the master integrated circuitry 230, the power conversion circuitry 240, and the battery 250, and may control overall operations for connection to, and power supply to, the external electronic device 203. The processor 210 may be, for example, a micro controlling unit (MCU), a field programmable gate array (FPGA), an application specific integrated circuit (ASIC), an application processor (AP), a control circuit, or a controller.

The input/output circuitry 220 according to an embodiment may include a pogo interface, and may be configured to transmit and receive data to and from the external electronic device 203 through the pogo interface, and to supply power output from the battery 250.

The master integrated circuitry 230 according to an embodiment may be electrically connected to the input/output circuitry 220 and the processor 210, and may be configured to identify connection and communication with the external electronic device 203 through an I/O data terminal (or line) of the pogo interface by using 1-wire communication. The master integrated circuitry 230 may generate an interrupt signal to the processor 210 by using I2C communication, and may transmit, to the processor 210, information received from the external electronic device 203 through the I/O data terminal by using I2C communication.

An embodiment of the power conversion circuitry 240 may be electrically connected to the battery 250 or the power management circuitry 260 connected to the battery 250, and may be electrically connected to the input/output circuitry 220, and may be configured to convert the voltage of power input from the battery 250. The power conversion circuitry 240 may be electrically connected to the processor 210, receive an enable signal from the processor 210, and receive, by using I2C communication a control signal for maintaining (e.g., maintaining at 3.3 V) or converting (e.g., converting to 5.1 V) an output voltage. The power conversion circuitry 240 may be configured to maintain the output voltage of the power to be supplied to the external electronic device 203 at a specified voltage value or to change the voltage value to a voltage value configured in relation to the external electronic device 203, and apply the voltage to the input/output circuitry 220 (e.g., a VCC terminal and a ground (GND) terminal of the pogo interface).

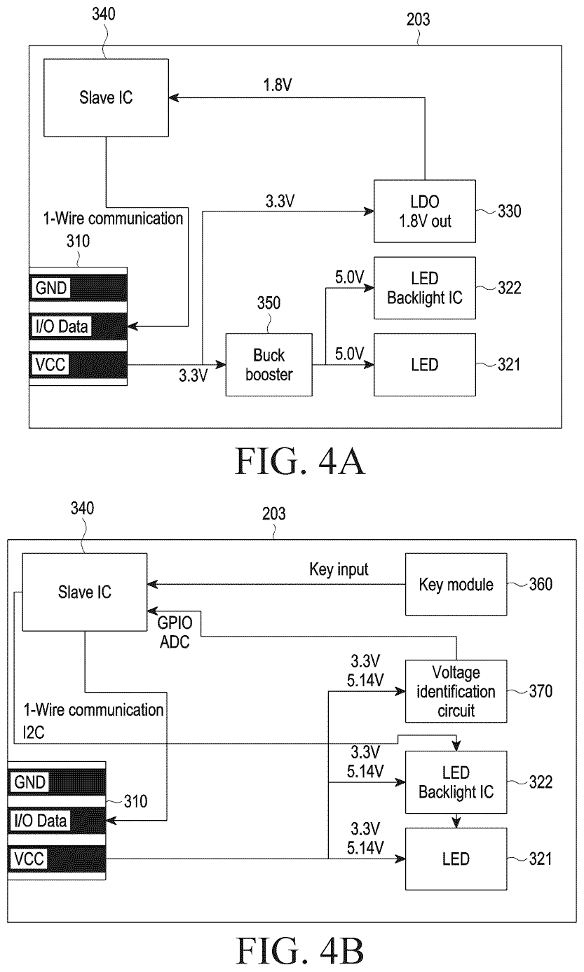

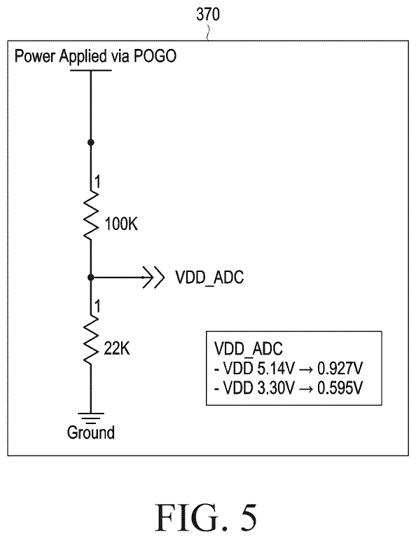

FIG. 4A and FIG. 4B illustrate the configuration of an external electronic device according to an embodiment, and FIG. 5 illustrates the configuration of voltage identification circuitry of an external electronic device according to an embodiment.

Referring to FIGS. 3, 4A, 4B, and 5, the external electronic device 203 according to an embodiment may be an accessory device, such as a keyboard, including at least one light emitting element (e.g., a light emitting diode (LED)). The external electronic device 203 according to an embodiment may include input/output circuitry 310, at least one light emitting element 321 (also referred to herein as a LED backlight IC), light emitting element management circuitry 322, a linear regulator (a low dropout (LDO)) 330, and slave integrated circuitry (IC) 340 (also referred to herein as slave direct circuitry). The external electronic device 203 according to an embodiment may further include a key module 360 or may include the key module 360 in place of the linear regulator 330, as illustrated in FIG. 4B. The external electronic device 203 according to an embodiment may include voltage identification circuitry 370 (also referred to herein as voltage verification circuitry) in place of the linear regulator 330, as illustrated in FIG. 4B. Without being limited thereto, the external electronic device 203 may further include other components which support performing at least one operation.

The input/output circuitry 310 of the external electronic device 203 according to an embodiment may be configured to connect to the electronic device 201 through the pogo interface and to communicate with the external electronic device 203, while communicating with the slave integrated circuitry 340 through a single communication line (e.g., 1-wire). The I/O circuitry 310 may apply an input voltage (e.g., 3.3 V or 5.1 V) of power supplied from the electronic device 201 through a voltage terminal (VCC) of the pogo interface to the at least one light emitting element 321, the light emitting element management circuitry 322, and the linear regulator (LDO: low dropout) 330. The I/O circuitry 310 may transmit, to the electronic device 201 through an I/O data terminal of the pogo interface, information (e.g., identification information and/or state information) related to the external electronic device and transmitted through the slave integrated circuitry 340.

The linear regulator (LDO) 330 according to an embodiment may be configured to operate even with a low input-to-output voltage difference and may convert an input voltage (e.g., 3.3 V) received through a VCC terminal of the pogo interface into a lower voltage (e.g., 1.8 V) for output and apply the output voltage to the slave integrated circuitry 340 for use as an operating power source.

The slave integrated circuitry 340 according to an embodiment may transmit information (e.g., identification information and LED state information) related to the external electronic device 203 to an I/O data terminal of the pogo interface through 1-wire communication.

The voltage identification circuitry 370 according to an embodiment may distribute an input voltage when power is applied through a voltage terminal (VCC) of the pogo interface. According to an embodiment, when the input voltage is applied as a first input voltage (e.g., 3.30 V), the voltage identification circuitry 370 may output a first division voltage (VDD_ADC) (e.g., 0.595 V) to the slave integrated circuitry 340 so as to identify an LED-off state by the slave integrated circuitry 340. The slave integrated circuitry 340 to which the first division voltage is applied may identify the LED-off state and transmit a control signal (e.g., a control signal for switching the LED to the off state) to the light emitting element management circuitry 322 through I2C communication. According to an embodiment, when the input voltage is applied as a second input voltage (e.g., 5.14 V), the voltage identification circuitry 370 may output a second division voltage (VDD_ADC) (e.g., 0.927 V) to the slave integrated circuitry 340. The slave integrated circuitry 340 to which the second division voltage is applied may identify the LED-on state and transmit a control signal (e.g., a control signal for switching the LED to the on state) to the light emitting element management circuitry 322 through I2C communication.

Referring again to FIG. 3, when the processor 210 of the electronic device 201 according to an embodiment identifies that the external electronic device 203 is connected, the processor 210 may control the power conversion circuitry 240 (also referred to herein as voltage conversion circuitry) to apply a specified first output voltage (e.g., 3.3 V) to an I/O data terminal of the pogo interface so as to supply power from the battery 250 to the external electronic device 203. The processor 210 may receive information related to the external electronic device 203 from the external electronic device 203 through the input/output circuitry 320. Based on identification information and/or state information included in the information related to the external electronic device 203, the processor 210 may control the power conversion circuitry 240 to maintain the first output voltage or to boost the output voltage to a second output voltage (e.g., 5.1 V).

According to an embodiment, the processor 210 may control the power conversion circuitry 240 to maintain the first output voltage when the processor 210 identifies, based on the identification information (e.g., a model name) of the external electronic device 203, that the external electronic device 203 is of a first type. According to an embodiment, the processor 210 may control the power conversion circuitry 240 to boost the output voltage to the second output voltage when the processor 210 identifies, based on the identification information of the external electronic device 203, that the external electronic device 203 is of a second type. The first type may indicate that the external electronic device includes a buck booster 350 that boosts an input voltage. The second type may indicate that the external electronic device does not include the buck booster 350.

According to an embodiment, the processor 210 may control the power conversion circuitry 240 to boost the output voltage to the second output voltage when the processor 210 identifies, based on the state information (e.g., LED configuration information or LED on/off state information), that the at least one light emitting element (LED) is in an on state, and may control the power conversion circuitry 240 to maintain the first output voltage when identifying that at least one LED is in an off state. Here, the second output voltage may be boosted to a voltage value supportive of driving at least one light emitting element 321.

According to an embodiment, after identifying the identification information of the external electronic device 203, the processor 210 may acquire and further identify statue information from the external electronic device 203. In an example in which the processor 210 identifies that the external electronic device 203 is of the first type and identifies that at least one LED is in an on state, the processor 210 may control the power conversion circuitry 240 to boost the output voltage to the second output voltage. Here, the second output voltage may be boosted to a voltage value supportive of driving at least one light emitting element 321. In an example in which the processor 210 identifies that the external electronic device 203 is of the first type and identifies that at least one LED is in an off state, the processor 210 may control the power conversion circuitry 240 to maintain the first output voltage.

According to an embodiment, after applying the second output voltage to the external electronic device 203, the processor 210 may wait for a specified time (e.g., a time delay). After the specified time has elapsed, when the processor 210 identifies, based on state information received from the external electronic device 203, that the at least one light emitting element is in an off state, the processor 210 may control the power conversion circuitry to change the second output voltage applied to the external electronic device 203 to the first output voltage. After the specified time (e.g., time delay) has elapsed, when the processor 210 identifies, based on the state information received from the external electronic device 203, that the at least one light emitting element is in an on state, the processor 210 may control the power conversion circuitry 240 to maintain the second output voltage applied to the external electronic device 203.

According to an embodiment, in response to receiving an event related to a state change (e.g., an event corresponding to identifying a key input for configuring the LED on) from the external electronic device 203, the processor 210 may control the power conversion circuitry 240 to change the first output voltage to the second output voltage. In an example in which the external electronic device 203 receives a key input for configuring the LED on through the key module 360, the slave integrated circuitry 340 may transmit, to the electronic device 201, state information indicating that the LED is on, and may transmit, to the light emitting element management circuitry 322, a control signal for switching the at least one light emitting element (LED) to the on state.

According to an embodiment, the processor 210 may obtain an ambient brightness value through at least one sensor and may obtain state information of a display (e.g., an on or off state). Based on at least one of the obtained ambient brightness value and the display state information, the processor 210 may configure an on or off state for at least one light emitting element (LED) 321 (e.g., the processor 210 may determine whether to turn the at least one LED on or off). Based on the configured on or off state, the processor 210 may control the power conversion circuitry 240 to change the output voltage of power supplied to the external electronic device 203 to the first output voltage or the second output voltage.

The electronic device 201 according to an embodiment may implement a software module for power supply (e.g., the program 140 of FIG. 1). The memory 130 of the electronic device 201 may store instructions for implementing the software module illustrated in FIG. 2. The at least one processor of the electronic device 201 illustrated in FIG. 2 may execute the instructions stored in the memory to implement the software module and may control hardware (e.g., the sensor module 176, the power management module 188, or the communication module 190 of FIG. 1) associated with functions of the software module.

The software module of the electronic device 201 according to an embodiment may be configured to include a kernel (or HAL), a framework (e.g., the middleware 144 of FIG. 1), and an application (e.g., the application 146 of FIG. 1). At least a portion of the software module may be preloaded onto the electronic device 201 or may be downloadable from a server (e.g., server 108).

As such, in an embodiment, the major components of the electronic device 101 illustrated in FIGS. 1 and 2 have been described. However, in various embodiments, not all the components illustrated in FIGS. 1 and 2 may be essential components, and the electronic device 101 may be implemented with more or fewer components than those illustrated. The locations of the major components of the electronic device 101 described with reference to FIGS. 1 and 2 may also vary according to various embodiments.

According to an embodiment, the electronic device (e.g., the electronic device 101 of FIG. 1 and the electronic device 201 of FIGS. 2 and 3) may include a battery (e.g., the battery 250 of FIG. 3), voltage conversion circuitry (e.g., the power conversion circuitry 240 of FIG. 3), input/output circuitry including a pogo interface (e.g., the input/output circuitry 220 of FIG. 3), at least one processor including processing circuitry, and memory (e.g., the memory 130 of FIG. 1) storing instructions.

According to an embodiment, the instructions, when individually or collectively executed by the at least one processor, cause the electronic device to control the input/output circuitry to connect to an external electronic device (e.g., the external electronic device 203 of FIGS. 2, 3, 4A, and 4B) through the pogo interface.

According to an embodiment, the instructions, when individually or collectively executed by the at least one processor, cause the electronic device to control the power conversion circuitry to apply a first output voltage to the pogo interface so as to supply power from the battery to the external electronic device.

According to an embodiment, the instructions, when individually or collectively executed by the at least one processor, cause the electronic device to receive information related to the external electronic device from the external electronic device through the input/output circuitry while the first output voltage is applied to the external electronic device.

According to an embodiment, the instructions, when individually or collectively executed by the at least one processor, cause the electronic device to, based on information related to the external electronic device, maintain the first output voltage or change the first output voltage to a second output voltage, and control the power conversion circuitry to apply the maintained first output voltage or the second output voltage to the pogo interface.

According to an embodiment, the information related to the external electronic device may include identification information of the external electronic device and/or state information of the external electronic device.

According to an embodiment, the second output voltage may be a voltage supportive of driving at least one light emitting element of the external electronic device, and may be boosted by the power conversion circuitry to a value greater than the first output voltage.

According to an embodiment, the instructions, when individually or collectively executed by the at least one processor, cause the electronic device to identify, based on the identification information, the type of the external electronic device as a first type, control, based on identifying the first type, the power conversion circuitry to maintain the first output voltage, identify, based on the identification information, the type of the external electronic device as a second type, and control, based on identifying the second type, the power conversion circuitry to change the first output voltage to the second output voltage.

According to an embodiment, the first type may indicate that the external electronic device includes a buck booster that boosts an input voltage.

According to an embodiment, the second type may indicate that the external electronic device does not include the buck booster.

According to an embodiment, the instructions, when individually or collectively executed by the at least one processor, cause the electronic device to identify a state of the at least one light emitting element included in the external electronic device, based on the state information.

According to an embodiment, the instructions, when individually or collectively executed by the at least one processor, cause the electronic device to control the power conversion circuitry to change the first output voltage to the second output voltage, based on identifying that the state of the at least one light emitting element identified based on the state information is an on state, and control the power conversion circuitry to maintain the first output voltage, based on identifying that the state of the at least one light emitting element identified based on the state information is an off state.

According to an embodiment, the instructions, when individually or collectively executed by the at least one processor, cause the electronic device to identify, based on the identification information, the type of the external electronic device as the second type, control the power conversion circuitry to change the first output voltage to the second output voltage, based on identifying that the state of the at least one light emitting element identified based on the state information is an on state, and control the power conversion circuitry to maintain the first output voltage, based on identifying that the state of the at least one light emitting element identified based on the state information is an off state.

According to an embodiment, the instructions, when individually or collectively executed by the at least one processor, cause the electronic device to apply the second output voltage to the external electronic device, identify that the at least one light emitting element is in an on state, based on state information received from the external electronic device after a specified time, and control the power conversion circuitry to maintain the second output voltage applied to the external electronic device.

According to an embodiment, the instructions, when individually or collectively executed by the at least one processor, cause the electronic device to apply the second output voltage to the external electronic device, identify that the at least one light emitting element is in an off state, based on state information received from the external electronic device after a specified time, and control the power conversion circuitry to change the second output voltage applied to the external electronic device to the first output voltage.

According to an embodiment, the instructions, when individually or collectively executed by the at least one processor, cause the electronic device to control the power conversion circuitry to change the first output voltage to the second output voltage in response to receiving an event related to a state change from the external electronic device.

According to an embodiment, the instructions, when individually or collectively executed by the at least one processor, cause the electronic device to obtain an ambient brightness value by at least one sensor of the electronic device, obtain state information (e.g., an on or off state) of a display of the electronic device, receive no information related to the external electronic device, configure an on or off state for the at least one light emitting element of the external electronic device, based on at least one of the ambient brightness value and the state information of the display, and maintain the output voltage of the power supplied to the external electronic device at the first output voltage or change the output voltage to the second output voltage, based on the configured on or off state.

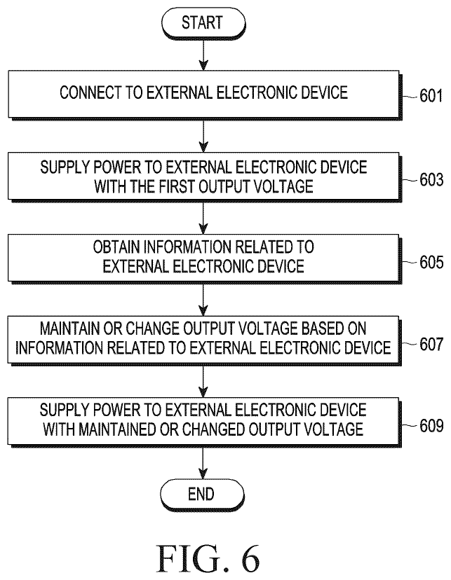

FIG. 6 illustrates an example of a method for operating an electronic device according to an embodiment. In the following embodiments, the operations may be sequentially performed but are not necessarily performed sequentially. For example, the order of the respective operations may be changed, and at least two of the operations may be performed in parallel.

Referring to FIG. 6, an electronic device (e.g., the electronic device 101 of FIG. 1 and the electronic device 201 of FIGS. 2 and 3) according to an embodiment may be connected to an external electronic device (e.g., the external electronic device 203 of FIGS. 2, 3, 4A, and 4B) through input/output circuitry (e.g., the input/output circuitry 220 of FIG. 3) in operation 601. The electronic device may identify a connection with the external electronic device through 1-wire communication via an I/O data terminal of the pogo interface.

In operation 603, the electronic device may apply a specified first output voltage (e.g., 3.3V) to a voltage terminal of the pogo interface so as to supply power from a battery (e.g., the battery 250 of FIG. 3) to the external electronic device.

In operation 605, the electronic device may acquire information related to the external electronic device from the external electronic device through the input/output circuitry.

In operation 607, the electronic device may maintain the specified first output voltage or change (or boost) the first output voltage to a second output voltage, based on the information related to the external electronic device.

In operation 609, the electronic device may apply, to the voltage terminal of the pogo interface, the maintained first output voltage or the second output voltage resulting from the change, thereby supplying power at the first output voltage or the second output voltage to the external electronic device.

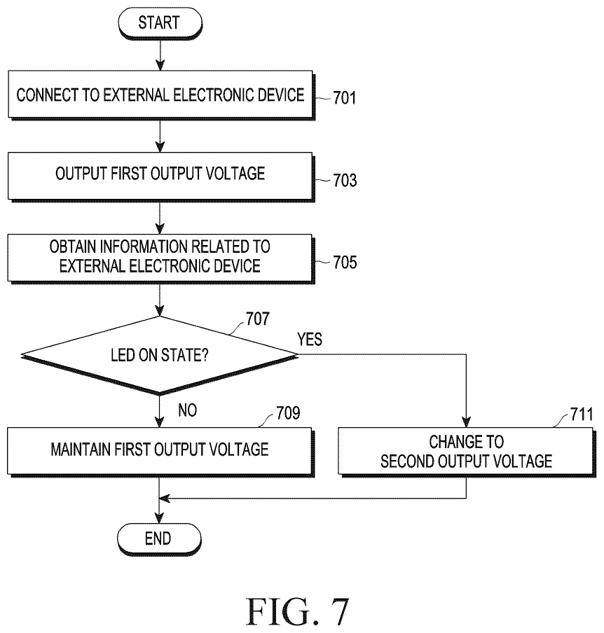

FIG. 7 illustrates an example of a method for operating an electronic device according to an embodiment. In the embodiments, the operations may be sequentially performed but are not necessarily performed sequentially. For example, the order of the respective operations may be changed, and at least two of the operations may be performed in parallel.

Referring to FIG. 7, in operation 701, an electronic device according to an embodiment (e.g., the electronic device 101 of FIG. 1 or the electronic device 201 of FIGS. 2 and 3) may be connected to an external electronic device (e.g., the external electronic device 203 of FIGS. 2, 3, 4A, and 4B) through input/output circuitry (e.g., the Input/output circuitry 220 of FIG. 3). The electronic device may identify the connection with the external electronic device through 1-wire communication via an I/O data terminal of the pogo interface.

In operation 703, the electronic device may apply a specified first output voltage (e.g., 3.3 V) to a voltage terminal of the pogo interface so as to supply power from a battery (e.g., the battery 250 of FIG. 3) to the external electronic device.

In operation 705, the electronic device may acquire information related to the external electronic device from the external electronic device through the input/output circuitry. The information related to the external electronic device may include state information indicating an on or off state for at least one light emitting element (e.g., an LED).

In operation 707, the electronic device may identify, based on the state information, whether the at least one light emitting element (e.g., an LED) is in an on state. In an example in which the identification result indicates that the at least one light emitting element is not in an on state, the electronic device may perform operation 709. In an example in which the identification result indicates that the at least one light emitting element is in an on state, the electronic device may perform operation 711.

In operation 709 (corresponding to No in operation 707), the electronic device may maintain the first output voltage currently being applied.

In operation 711 (corresponding to Yes in operation 707), the electronic device may change (or boost), to the second output voltage, the first output voltage currently being applied.

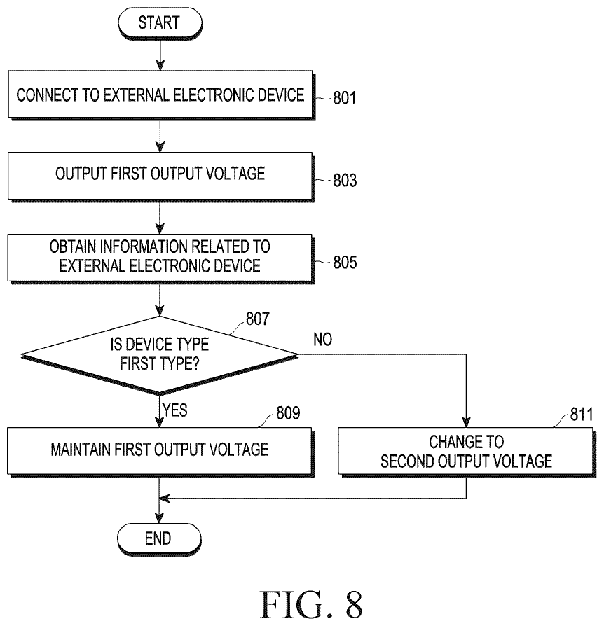

FIG. 8 illustrates an example of a method for operating an electronic device according to an embodiment. In the following embodiments, the operations may be sequentially performed but are not necessarily performed sequentially. For example, the order of the respective operations may be changed, and at least two of the operations may be performed in parallel.

Referring to FIG. 8, in operation 801, an electronic device according to an embodiment (e.g., the electronic device 101 of FIG. 1 or the electronic device 201 of FIGS. 2 and 3) may be connected to an external electronic device (e.g., the external electronic device 203 of FIGS. 2, 3, 4A, and 4B) through input/output circuitry (e.g., the Input/output circuitry 220 of FIG. 3). The electronic device may identify the connection with the external electronic device through 1-wire communication via an I/O data terminal of the pogo interface.

In operation 803, the electronic device may apply a specified first output voltage (e.g., 3.3 V) to a voltage terminal of the pogo interface so as to supply power from a battery (e.g., the battery 250 of FIG. 3) to the external electronic device.

In operation 805, the electronic device may acquire information related to the external electronic device from the external electronic device through the input/output circuitry. The information related to the external electronic device may include identification information (e.g., a product model name) of the external electronic device.

In operation 807, the electronic device may identify, based on the identification information, whether the type of the external electronic device is a first type. In an example in which the identification result indicates that the external electronic device is of the first type, the electronic device may perform operation 809. In an example in which the identification result indicates that the external electronic device is not of the first type, the electronic device may perform operation 811.

In operation 809 (corresponding to No in operation 807), based on identifying that the external electronic device is of the first type, the electronic device may maintain the first output voltage currently being applied.

In operation 811 (corresponding to Yes in operation 807), based on identifying that the type of the external electronic device is a second type other than the first type, the electronic device may change (or boost), to the second output voltage, the first output voltage currently being applied.

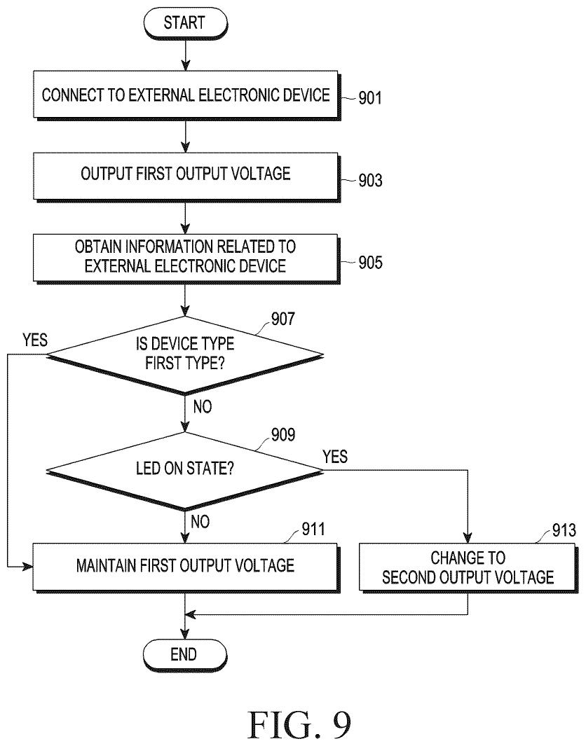

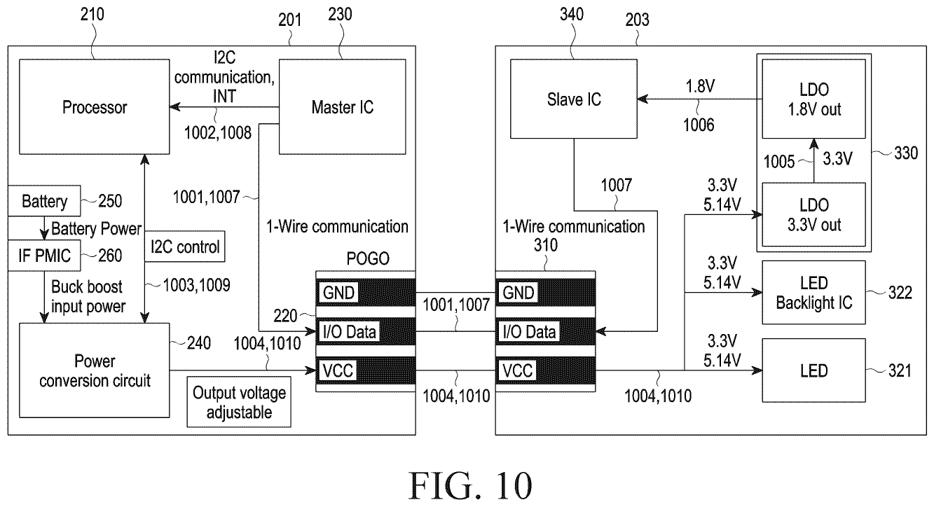

FIG. 9 illustrates an example of a method for operating an electronic device according to an embodiment, and FIG. 10 illustrates an example of a method for operating an electronic device and an external electronic device according to an embodiment. In the following embodiments, the operations may be sequentially performed but are not necessarily performed sequentially. For example, the order of the respective operations may be changed, and at least two of the operations may be performed in parallel.

Referring to FIGS. 9 and 10, in operation 901, an electronic device according to an embodiment (e.g., the electronic device 101 of FIG. 1 or the electronic device 201 of FIGS. 2 and 3) may be connected to an external electronic device (e.g., the external electronic device 203 of FIGS. 2, 3, 4A, and 4B) through input/output circuitry (e.g., the Input/output circuitry 220 of FIG. 3). The electronic device may identify the connection with the external electronic device through 1-wire communication via an I/O data terminal of the pogo interface.

In operation 903, the electronic device may apply a specified first output voltage (e.g., 3.3 V) to a voltage terminal of the pogo interface so as to supply power from a battery (e.g., the battery 250 of FIG. 3) to the external electronic device.

In operation 905, the electronic device may acquire information related to the external electronic device from the external electronic device through the input/output circuitry. The information related to the external electronic device may include identification information (e.g., a product model name) of the external electronic device and state information indicating an on or off state for at least one light emitting element (e.g., an LED).

In operation 907, the electronic device may identify, based on the identification information, whether the type of the external electronic device is a first type. In an example in which the identification result indicates that the external electronic device is of the first type, the electronic device may perform operation 911. In an example in which the identification result indicates that the external electronic device is not of the first type, the electronic device may perform operation 909.

In operation 909 (corresponding to No in operation 907), the electronic device may identify, based on the state information, whether the at least one light emitting element (e.g., an LED) is in an on state. In an example in which the identification result indicates that the at least one light emitting element is not in an on state, the electronic device may perform operation 911. In an example in which the identification result indicates that the at least one light emitting element is in an on state, the electronic device may perform operation 913.

In operation 911 (corresponding to Yes in operation 907 and No in operation 909), the electronic device may maintain the first output voltage currently being applied.

In operation 913 (corresponding to Yes in operation 909), the electronic device may change (or boost), to the second output voltage, the first output voltage currently being applied.

FIG. 10 illustrates an example of a method for operating an electronic device and an external electronic device according to an embodiment. In the following embodiments, the operations may be sequentially performed but are not necessarily performed sequentially. For example, the order of the respective operations may be changed, and at least two of the operations may be performed in parallel. Each of the operations of the electronic device in the following embodiments may correspond to the operations described in the above-described operating methods in FIG. 6 to FIG. 9.

Referring to FIG. 10, the electronic device 201 (e.g., the electronic device 101 of FIG. 1 and the electronic device 201 of FIGS. 2 and 3) according to an embodiment may, in operation 1001, be connected to an external electronic device (e.g., the external electronic device 203 of FIGS. 2, 3, 4A, and 4B) through input/output circuitry 220 (e.g., the input/output circuitry 220 of FIG. 3). The electronic device 201 may transmit, through 1-wire communication via an I/O data terminal of the pogo interface, information (or a signal) related to the connection with the external electronic device 203 to the master integrated circuitry (IC) 230.

In operation 1002, when the master integrated circuitry 230 receives information (or a signal) related to connection, the electronic device 201 may generate an interrupt signal to the processor 210 by the master integrated circuitry 230.

In operation 1003, the electronic device 201 may cause the processor 210 to transmit, to the power conversion circuitry 240, a control signal for supplying power from the battery 250 to an external electronic device. Accordingly, in the electronic device (201), the power from the battery 250 may be applied to the power conversion circuitry 240.

In operation 1004, when power is applied from the battery 250, the electronic device 201 may apply a specified first output voltage (e.g., 3.3V) to the voltage terminal of the pogo interface by the power conversion circuitry 240. The first output voltage may be applied to the voltage terminal (VCC) of the pogo interface of the external electronic device that is connected to the voltage terminal (VCC) of the pogo interface. In this case, when the first output voltage is applied to the voltage terminal (VCC) of the pogo interface of the input/output circuitry 310, the external electronic device 203 may cause the input/output circuitry 310 to apply the first output voltage, as a first input voltage, to at least one light emitting element 321, a light emitting element management circuitry 322, and a linear regulator (LDO) 330.

In operation 1005, the external electronic device 203 may output, through the linear regulator (LDO) 330, the applied first output voltage as a driving voltage (e.g., 1.8V) of the slave integrated circuitry 340.

In operation 1007, when the driving voltage is applied, the external electronic device 203 may transmit, through the slave integrated circuitry 340, information related to the external electronic device (e.g., identification information and/or status information) via 1-wire communication, and may transmit the information (e.g., identification information and/or status information) related to the external electronic device to the electronic device 201 through an I/O data terminal of the pogo interface of the input/output circuitry 310. In this case, the electronic device 201 may transmit, to the master integrated circuitry 230 through 1-wire communication, information related to the external electronic device transmitted through the I/O data (data) terminal of the pogo interface by the input/output circuitry 220.

In operation 1008, the electronic device 201 may cause the master integrated circuitry 230 to transmit the delivered information related to the external electronic device to the processor 210.

In operation 1009, the electronic device 201 may cause the processor 210 to identify, based on the delivered information related to the external electronic device, whether to maintain the first output voltage or to change (or boost) the first output voltage to a second output voltage, and transmit a control signal corresponding to the identification result to the power conversion circuitry 240.

In operation 1010, when the power conversion circuitry 240 receives the control signal from the processor 210, the electronic device 201 may cause the power conversion circuitry 240 to maintain the first output voltage (e.g., 3.3 V) or change the first output voltage to the second output voltage (e.g., 5.14 V), and may apply the output voltage to the voltage terminal (VCC) of the pogo interface of the external electronic device 203 through the voltage terminal (VCC) of the pogo interface of the input/output circuitry 220. Expressed another way, the electronic device 201 may control the power conversion circuitry 240 to apply, as the output voltage, the first output voltage (e.g., 3.3 V) or the second output voltage (e.g., 5.14 V). In this case, when the first output voltage (e.g., 3.3 V) or the second output voltage (e.g., 5.14 V) is applied to the voltage terminal (VCC) of the pogo interface of the input/output circuitry 310, the external electronic device 203 may cause the input/output circuitry 310 to apply the first input voltage corresponding to the first output voltage or the second input voltage corresponding to the second output voltage to the at least one light emitting element 321, the light emitting element management circuitry 322, and the linear regulator (LDO) 330.

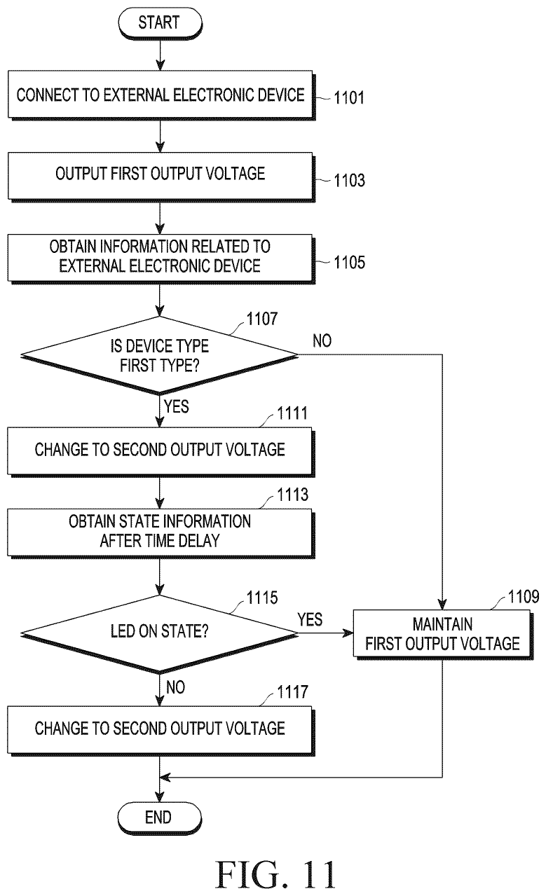

FIG. 11 illustrates an example of a method for operating an electronic device according to an embodiment. In the following embodiments, the operations may be sequentially performed but are not necessarily performed sequentially. For example, the order of the respective operations may be changed, and at least two of the operations may be performed in parallel.

Referring to FIG. 11, in operation 1101, an electronic device according to an embodiment (e.g., the electronic device 101 of FIG. 1 or the electronic device 201 of FIGS. 2 and 3) may be connected to an external electronic device (e.g., the external electronic device 203 of FIGS. 2, 3, 4A, and 4B) through input/output circuitry (e.g., the Input/output circuitry 220 of FIG. 3). The electronic device may identify the connection with the external electronic device through 1-wire communication via an I/O data terminal of the pogo interface.

In operation 1103, the electronic device may apply a specified first output voltage (e.g., 3.3 V) to a voltage terminal of the pogo interface so as to supply power from a battery (e.g., the battery 250 of FIG. 3) to the external electronic device.

In operation 1105, the electronic device may acquire information related to the external electronic device from the external electronic device through the input/output circuitry. The information related to the external electronic device may include identification information (e.g., a product model name) of the external electronic device and state information indicating an on or off state for at least one light emitting element (e.g., an LED).

In operation 1107, the electronic device may identify, based on the identification information, whether the type of the external electronic device is a first type. In an example in which the identification result indicates that the external electronic device is of the first type, the electronic device may perform operation 1109. In an example in which the identification result indicates that the external electronic device is not of the first type, the electronic device may perform operation 1111.

In operation 1109 (corresponding to No in operation 1107 and No in operation 1115), based on identifying that the external electronic device is of the first type, the electronic device may maintain the first output voltage currently being applied. The electronic device may apply the maintained first output voltage to the external electronic device through the input/output circuitry.

In operation 1111 (corresponding to Yes in operation 1107), based on identifying that the type of the external electronic device is the second type other than the first type, the electronic device may change (or boost), to a second output voltage (e.g., 5.14 V), the first output voltage currently being applied. The electronic device may apply, to the external electronic device through the input/output circuitry, the second output voltage resulting from the change.

In operation 1113, the electronic device may delay (or wait) for a specified time (e.g., 1 to 5 seconds), and then may acquire state information related to the at least one light emitting element (e.g., an LED).

In operation 1115, the electronic device may identify, based on the acquired state information, whether the at least one light emitting element (e.g., an LED) is in an on state. In an example in which the identification result indicates that the at least one light emitting element is in an on state, the electronic device may perform operation 1117. In an example in which the identification result indicates that the at least one light emitting element is not in an on state, the electronic device may perform operation 1109.

In operation 1117 (corresponding to No in operation 1115), based on identifying that the at least one light emitting element (e.g., an LED) is in an off state rather than in an on state, the electronic device may change (or reduce), to the first output voltage, the second output voltage currently being applied to the external electronic device. The electronic device may apply, to the external electronic device through the input/output circuitry, the first output voltage resulting from the change.

According to an embodiment, when a key input for changing the state (e.g., LED on or LED off) of at least one light emitting element (e.g., an LED) is generated by a key module (e.g., the key module 360 of FIG. 4B) of the external electronic device, the external electronic device may cause the slave integrated circuitry 340 to transmit, to the light emitting element management circuitry 322, a command (e.g., a control signal) for adjusting brightness of the at least one light emitting element (e.g., an LED). In an example in which the key input is generated, the external electronic device may transmit, to the electronic device, an event according to the key input as state information. Based on the delivered state information, the electronic device may identify the event corresponding to the key input, and may configure an output voltage (e.g., the first output voltage or the second output voltage) based on the changed state (e.g., LED on or LED off) of the at least one light emitting element according to the event corresponding to the key input, and may apply the output voltage to the external electronic device. In an example in which the at least one light emitting element is in an on state, the electronic device may change the power to power of the second output voltage (e.g., 5.14V) and supply the power of the second output voltage to the external electronic device. In an example in which the at least one light emitting element is in an off state, the electronic device may supply power of the first output voltage (e.g., 3.3V) to the external electronic device.

According to an embodiment, as in the operating method described with reference to FIGS. 6 to 11 above, the electronic device may exchange state information (e.g., LED on/off stage information) included in information related to the external electronic device with the external electronic device, and may change a voltage according to the on/off of the at least one light emitting element (e.g., an LED). In such an operating method, when the timing between a voltage-change signal transmitted through 1-wire communication and an actual change in an output voltage performed by the power conversion circuitry does not match, the brightness may fail to change because the voltage may be changed after the LED is turned on. To prevent this, a voltage applied to the at least one light emitting element may be identified by voltage verification circuitry of the external electronic device (e.g., the voltage identification circuitry 370 of FIG. 4B), and the slave direct circuitry may determine the on/off state for the at least one light emitting element (e.g., LED) based on the identified voltage and may transmit the determined state information to the electronic device.

According to an embodiment, the electronic device may identify an event (e.g., an event corresponding to identifying a key input for configuring the LED on) related to a state change resulting from a key input, the event being included in the state information (e.g., LED on stage information), and, when the event indicates LED on, may transmit, through the processor, a control signal for changing the output voltage to the power conversion circuitry, may have the power conversion circuitry change the output voltage to the second output voltage (e.g., 5.14 V) and output the second output voltage, and may apply the second output voltage to the external electronic device. The second output voltage may be applied to at least one light emitting element (e.g., the at least one light emitting element 321 of FIGS. 3, 4A, and 4B), a light emitting element management circuitry (e.g., the light emitting element 321 of FIGS. 3, 4A, and 4B), and voltage identification circuitry (e.g., the voltage identification circuitry 370 of FIG. 4B) of the external electronic device. The external electronic device may transmit an LED on operation command to the light emitting element management circuitry by the slave direct circuitry (e.g., the slave integrated circuitry 340 of FIGS. 3, 4A, and 4B) via I2C communication, and may control the light emitting element management circuitry to switch the state of at least one light emitting element to an LED on state.

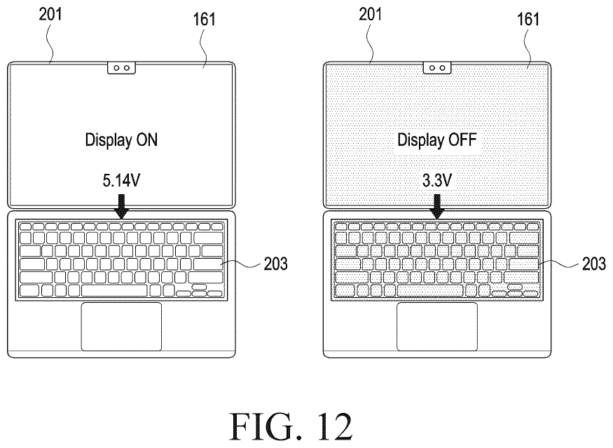

FIG. 12 illustrates an example of a method for operating an electronic device according to an embodiment.

Referring to FIG. 12, according to an embodiment, the electronic device 201 may acquire an ambient brightness value by at least one sensor (e.g., an illuminance sensor) of the electronic device 201, and may acquire display state information (display on or display off state information) for the display 161 of the electronic device. The electronic device 201 may configure an on or off state for at least one light emitting element (LED) (e.g., the at least one light emitting element (LED) 321 of FIGS. 3, 4A, and 4B), based on at least one of the acquired ambient brightness value or the display state information. The electronic device 201 may maintain the output voltage of power supplied to the external electronic device 203 as the first output voltage or change the output voltage to the second output voltage, based on the configured on or off state, and may apply, to the external electronic device 203, the maintained first output voltage or the second output voltage resulting from the change.

According to an embodiment, the electronic device 201 may directly configure the on or off state for the at least one light emitting element (LED) 321 based on at least one of the ambient brightness value or the display state information, even when information related to the external electronic device is not received or before the information is received, prior to initially applying a specified output voltage after identifying a connection with the external electronic device 203.

According to an embodiment, when the brightness level of LED on in the external electronic device 203 is configured to, for example, level 3, the electronic device 201 may detect an ambient brightness value by using, for example, an illuminance sensor. In an example in which the ambient brightness value is equal to or greater than a threshold value (e.g., 20,000 lux for outdoor activity), due to the brightness of external light, the visibility is poor even when at least one light emitting element (e.g., an LED) of the external electronic device 203 is in the on state. In this case, the electronic device 101 may determine that it is a situation in which it is difficult to distinguish the LED on/off state by the ambient brightness value. The electronic device may determine, according to the determined situation, that the LED on operation is unnecessary, and may change (or reduce) the currently applied second output voltage (e.g., 5.14 V) to the specified first output voltage (e.g., 3.3 V). The external electronic device 203, upon identifying through the voltage detection circuitry that an analog-digital converter (ADC) value is changed to a voltage value (e.g., 3.3V) corresponding to the first output voltage in the LED on configuring situation, may switch at least one light emitting element (e.g., an LED) to the off state.

According to an embodiment, when the electronic device 201 identifies that the ambient brightness value does not indicate a situation in which it is difficult to distinguish the LED on/off state, the electronic device may again boost the output voltage to the second output voltage (e.g., 5.14 V) and apply the same to the external electronic device 203. In an example in which the second output voltage (e.g., 5.14 V) is applied, the external electronic device may switch at least one light emitting element (e.g., an LED) to the on state based on a predetermined user configuring condition and may configure (or adjust) the brightness level (step 1, 2, or 3) in the on state. As the at least one light emitting element (e.g., an LED) is switched to the off state and the output voltage is additionally reduced to the first output voltage (e.g., 3.3 V), the electronic device 201 may a benefit in the current consumed by the electronic device 201.

According to an embodiment, when the state of at least one light emitting element (e.g., an LED) is configured to the on state, if no key input is received in the external electronic device, the external electronic device may transition to a suspend mode after, for example, 15 seconds, and at least one light emitting element (e.g., an LED) may also be switched to the off state. Since this operation is not linked with the activation (active) or sleep state of the electronic device 201 and may operate independently, the operation in which the state is switched to the off state as the external electronic device transitions to the suspend mode may be able to interlock with changes in the output voltage applied to the external electronic device 203, based on the LED on/off state that is configured in the electronic device 201 according to the display on/off state.

According to an embodiment, because the external electronic device 203 performs the LED on/off operation through voltage identification without passing through 1-wire communication, the external electronic device may control the LED on/off operation of at least one light emitting element (e.g., an LED) based on the display state (e.g., display on/off state) of the electronic device 201 without a large delay. Accordingly, the external electronic device may switch the at least one light emitting element (e.g., an LED) to the off state by configuring (or changing) a standby time (e.g., 30 seconds) in association with the automatic screen-off time (e.g., 30 seconds) of the electronic device. The electronic device may provide, on the display 161, a configuring screen including option items that allow the user to select whether to use the predetermined standby time (e.g., 15 seconds) of the external electronic device or whether to interlink with the automatic screen-off time (e.g., 30 seconds), in consideration of the current consumed by the electronic device.

According to an embodiment, a method for operating an electronic device (e.g., the electronic device 101 of FIG. 1 and the electronic device 201 of FIGS. 2, 3, 10, and 12) may include connecting to an external electronic device (e.g., the external electronic device 203 of FIGS. 2, 3, 4A, 4B, 10, and 12) through a pogo interface included in input/output circuitry (e.g., the input/output circuitry 220 of FIGS. 3 and 10) of the electronic device.

According to an embodiment, the method may include applying a first output voltage to the pogo interface so as to supply power from a battery (e.g., the battery 250 of FIGS. 3 and 10) of the electronic device to the external electronic device.

According to an embodiment, the method may include receiving, from the external electronic device through the input/output circuitry, information related to the external electronic device while applying the first output voltage to the external electronic device.

According to an embodiment, the method may include maintaining the first output voltage or changing the first output voltage to a second output voltage based on the information related to the external electronic device.

According to an embodiment, the method may include applying, to the pogo interface, the maintained first output voltage or the second output voltage resulting from the change.

According to an embodiment, the information related to the external electronic device may include identification information of the external electronic device and/or state information of the external electronic device.

According to an embodiment, the second output voltage may be a voltage supportive of driving at least one light emitting element of the external electronic device, and may be boosted to a value greater than the first output voltage by voltage conversion circuitry of the electronic device.

According to an embodiment, the maintaining of the first output voltage or changing of the first output voltage to the second output voltage may include identifying a type of the external electronic device as a first type based on the identification information, maintaining the first output voltage based on identifying the first type, identifying the type of the external electronic device as a second type based on the identification information, and changing the first output voltage to the second output voltage based on identifying the second type.

According to an embodiment, the first type may indicate that the external electronic device includes a buck-boost converter for boosting the input voltage.

According to an embodiment, the second type may indicate that the external electronic device does not include the buck-boost converter.

According to an embodiment, the maintaining of the first output voltage or changing of the first output voltage to the second output voltage may include changing the first output voltage to the second output voltage based on identifying that a state of the at least one light emitting element, which is identified based on the state information, is an on state, and maintaining the first output voltage based on identifying that the state of the at least one light emitting element, which is identified based on the state information, is an off state.

According to an embodiment, the maintaining of the first output voltage or changing of the first output voltage to the second output voltage may include identifying the type of the external electronic device as the second type based on the identification information, changing the first output voltage to the second output voltage based on identifying that the state of the at least one light emitting element, which is identified base on the state information, is an on state, and maintaining the first output voltage based on identifying that the state of the at least one light emitting element, which is identified based on the state information, is an off state.

According to an embodiment, the method may further include, after the second output voltage has been applied to the external electronic device and after a specified time has elapsed, based on state information received from the external electronic device, identifying that a state of the at least one light emitting element is an on state, and maintaining the second output voltage applied to the external electronic device.

According to an embodiment, the method may further include, after the second output voltage has been applied to the external electronic device and after a specified time has elapsed, based on state information received from the external electronic device, identifying that a state of the at least one light emitting element is an off state, and changing, to the first output voltage, the second output voltage applied to the external electronic device.

According to an embodiment, the method may further include changing the first output voltage to the second output voltage in response to receiving, from the external electronic device, an event related to a state change.

According to an embodiment, the method may further include obtaining an ambient brightness value by at least one sensor of the electronic device, configuring an on or off state for the at least one light emitting element of the external electronic device based on the ambient brightness value without receiving information related to the external electronic device, and maintaining an output voltage of power supplied to the external electronic device at the first output voltage or changing the output voltage to the second output voltage based on the configured on or off state.

According to an embodiment, the method may further include obtaining state information of a display of the electronic device, determining an on or off state for the at least one light emitting element of the external electronic device based on the state information of the display without receiving information related to the external electronic device, and maintaining the output voltage at the first output voltage or changing the output voltage to the second output voltage based on the determined on or off state.

According to an embodiment, a non-transitory storage medium stores one or more programs, the one or more programs may include instructions that, when executed by at least one processor of an electronic device (e.g., the processor 120 of the electronic device 101 of FIG. 1 and the processor 210 of the electronic device 201 of FIGS. 2, 3, 10, and 12), cause the electronic device to connect to an external electronic device (e.g., the external electronic device 203 of FIGS. 2, 3, 4A, 4B, 10, and 12) through a pogo interface included in input/output circuitry of the electronic device (e.g., the input/output circuitry 220 of FIGS. 3 and 10), apply a first output voltage to the pogo interface so as to supply power from a battery (e.g., the battery 250 of FIGS. 3 and 10) of the electronic device to the external electronic device, receive information related to the external electronic device from the external electronic device through the input/output circuitry while the first output voltage is being applied to the external electronic device, maintain the first output voltage or change the first output voltage to a second output voltage based on the information related to the external electronic device, and apply, to the pogo interface, the maintained first output voltage or the second output voltage resulting from the change.

Various effects that are directly or indirectly understood from this document may also be provided. The effects obtainable from the disclosure are not limited to those mentioned above, and other effects that are not explicitly described will be clearly understood by those skilled in the art from the following description.

The embodiments disclosed in this document are presented for the purpose of describing and facilitating understanding of the disclosed technical features, and are not intended to limit the scope of the technology described herein. Therefore, the scope of this document should be interpreted as including all modifications or various other embodiments based on the technical spirit of this document.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described herein.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is

1. An electronic device comprising:
a battery;
power conversion circuitry;
input/output circuitry comprising a pogo interface;
at least one processor comprising processing circuitry; and
a memory storing instructions,
wherein the instructions, when executed by the at least one processor individually or collectively, cause the electronic device to:
control the input/output circuitry to connect with an external electronic device through the pogo interface;
control the power conversion circuitry to apply a first output voltage to the pogo interface to supply power from the battery to the external electronic device;
receive information related to the external electronic device from the external electronic device through the input/output circuitry while the first output voltage is applied to the external electronic device;
based on the information related to the external electronic device, maintain the first output voltage or change the first output voltage to a second output voltage; and
control the power conversion circuitry to apply the maintained first output voltage or the second output voltage to the pogo interface.

2. The electronic device of claim 1,
wherein the information related to the external electronic device comprises identification information of the external electronic device, state information of the external electronic device, or both,
wherein the second output voltage is a voltage which drives at least one light emitting element of the external electronic device and is a value greater than the first output voltage, and the power conversion circuitry boosts the first output voltage to the second output voltage,
wherein the instructions, when executed by the at least one processor individually or collectively, cause the electronic device to:
based on the identification information, identify a type of the external electronic device as a first type, and based on identifying the first type, control the power conversion circuitry to maintain the first output voltage; and
based on the identification information, identify the type of the external electronic device as a second type, and based on identifying the second type, control the power conversion circuitry to change the first output voltage to the second output voltage;
wherein the first type indicates that the external electronic device comprises a buck booster for boosting an input voltage, and
wherein the second type indicates that the external electronic device does not comprise the buck booster.

3. The electronic device of claim 2, wherein the instructions, when executed by the at least one processor individually or collectively, cause the electronic device to:
based on identifying that a state of the at least one light emitting element, which is identified based on the state information, is an on state, control the power conversion circuitry to change the first output voltage to the second output voltage; and
based on identifying that a state of the at least one light emitting element, which is identified based on the state information, is an off state, control the power conversion circuitry to maintain the first output voltage.

4. The electronic device of claim 2, wherein the instructions, when executed by the at least one processor individually or collectively, cause the electronic device to:
based on the identification information, identify the type of the external electronic device as the second type;
based on identifying that a state of the at least one light emitting element, which is identified based on the state information, is an on state, control the power conversion circuitry to change the first output voltage to the second output voltage; and
based on identifying that the state of the at least one light emitting element, which is identified based on the state information, is an off state, control the power conversion circuitry to maintain the first output voltage.

5. The electronic device of claim 1, wherein the instructions, when executed by the at least one processor individually or collectively, cause the electronic device to:
apply the second output voltage to the external electronic device;
after a specified time, based on state information received from the external electronic device, identify that a state of at least one light emitting element is an on state; and
control the power conversion circuitry to maintain the second output voltage applied to the external electronic device.

6. The electronic device of claim 1, wherein the instruction, when executed by the at least one processor individually or collectively, cause the electronic device to:
apply the second output voltage to the external electronic device;
after a specified time, based on state information received from the external electronic device, identify that a state of at least one light emitting element is an off state;
control the power conversion circuitry to change the second output voltage applied to the external electronic device to the first output voltage; and
in response to receiving an event related to a state change from the external electronic device, control the power conversion circuitry to change the first output voltage to the second output voltage.

7. The electronic device of claim 1, wherein the instructions, when executed by the at least one processor individually or collectively, cause the electronic device to:
obtain an ambient brightness value using at least one sensor of the electronic device;
obtain state information of a display of the electronic device;
based on at least one of the ambient brightness value or the state information of the display, and without receiving the information related to the external electronic device, configure an on or off state for at least one light emitting element of the external electronic device; and
based on the set on or off state, maintain an output voltage of power supplied to the external electronic device at the first output voltage or change the output voltage to the second output voltage.

8. An operation method of an electronic device, the operation method comprising:
connecting to an external electronic device through a pogo interface comprised in input/output circuitry of the electronic device;
applying a first output voltage to the pogo interface to supply power from a battery of the electronic device to the external electronic device;
receiving information related to the external electronic device from the external electronic device through the input/output circuitry while applying the first output voltage to the external electronic device;
based on the information related to the external electronic device, maintaining the first output voltage or changing the first output voltage to a second output voltage; and
applying the maintained first output voltage or the second output voltage to the pogo interface.

9. The operation method of claim 8, wherein the information related to the external electronic device comprises identification information of the external electronic device, state information of the external electronic device, or both,
wherein the second output voltage is a voltage which drives at least one light emitting element of the external electronic device and is a value greater than the first output voltage, and
the changing of the first output voltage to the second output voltage comprises boosting the first output voltage to the second output voltage using power conversion circuitry of the electronic device,
wherein the maintaining of the first output voltage or changing to the second output voltage comprises:
based on the identification information, identifying a type of the external electronic device as a first type, and based on identifying the first type, maintaining the first output voltage; and
based on the identification information, identifying a type of the external electronic device as a second type, and based on identifying the second type, changing the first output voltage to the second output voltage,
wherein the first type indicates that the external electronic device comprises a buck booster which boosts an input voltage, and
wherein the second type indicates that the external electronic device does not comprise the buck booster.

10. The operation method of claim 9, wherein the maintaining of the first output voltage or changing to the second output voltage comprises:
based on identifying that a state of the at least one light emitting element, which is identified based on the state information, is an on state, changing the first output voltage to the second output voltage; and
based on identifying that a state of the at least one light emitting element, which is identified based on the state information, is an off state, maintaining the first output voltage.

11. The operation method of claim 9, wherein the maintaining of the first output voltage or changing to the second output voltage comprises:
based on the identification information, identifying a type of the external electronic device as the second type;
based on identifying that a state of the at least one light emitting element, which is identified based on the state information, is an on state, changing the first output voltage to the second output voltage; and
based on identifying that the state of the at least one light emitting element, which is identified based on the state information, is an off state, maintaining the first output voltage.

12. The operation method of claim 8, further comprising:
after a specified period of time after applying the second output voltage to the external electronic device, based on state information received from the external electronic device, identifying that a state of at least one light emitting element is an on state, and maintaining the second output voltage applied to the external electronic device;
after the specified period of time after applying the second output voltage to the external electronic device, based on the state information received from the external electronic device, identifying that the state of the at least one light emitting element is an off state, and changing the second output voltage, applied to the external electronic device, to the first output voltage; and
in response to receiving an event related to a state change from the external electronic device, changing the first output voltage to the second output voltage.

13. The operation method of claim 8, further comprising:
acquiring an ambient brightness value by at least one sensor of the electronic device;
based on the ambient brightness value, and without receiving the information related to the external electronic device, configuring an on or off state for at least one light emitting element of the external electronic device; and
based on the configured on or off state, maintaining an output voltage of power supplied to the external electronic device at the first output voltage or changing the output voltage to the second output voltage.

14. The operation method of claim 8, further comprising:
acquiring state information of a display of the electronic device;
based on the state information of the display without receiving the information related to the external electronic device, configuring an on or off state for at least one light emitting element of the external electronic device; and
based on the configured on or off state, maintaining an output voltage of power supplied to the external electronic device at the first output voltage or changing the output voltage to the second output voltage.

15. A non-transitory storage medium storing one or more programs,
wherein the one or more programs comprise instructions that, when executed by at least one processor of an electronic device, cause the electronic device to perform:
connecting to an external electronic device through a pogo interface comprised in input/output circuitry of the electronic device;
applying a first output voltage to the pogo interface to supply power from a battery of the electronic device to the external electronic device;
receiving information related to the external electronic device from the external electronic device through the input/output circuitry while applying the first output voltage to the external electronic device;
based on the information related to the external electronic device, maintaining the first output voltage or changing the first output voltage to a second output voltage; and
applying the maintained first output voltage or the second output voltage to the pogo interface.
